(19) United States
(12) Patent Application Publication
(10) Pub. No.: US 2022/0083291 A1
(43) Pub. Date: Mar. 17, 2022

(54) PRINT CONTROL APPARATUS AND NON-TRANSITORY COMPUTER READABLE MEDIUM

(71) Applicant: FUJIFILM Business Innovation Corp., Tokyo (JP)

(72) Inventor: Takashi BETSUYAKU, Kanagawa (JP)

(73) Assignee: FUJIFILM Business Innovation Corp., Tokyo (JP)

(21) Appl. No.: 17/225,130

(22) Filed: Apr. 8, 2021

(30) Foreign Application Priority Data
Sep. 16, 2020 (JP) 2020-155537

(51) Int. Cl. G06F 3/12; G06K 15/02; G06K 15/00

(52) U.S. Cl. CPC G06F 3/1219; G06F 3/1234; G06F 3/1259; G06K 15/4065; G06F 3/126; G06K 15/022

(57) ABSTRACT

A print control apparatus includes a processor configured to acquire a remaining capacity of a continuous paper strip on which a result of executing a job is printed, acquire a capacity of printed material requiring reprinting, the printed material being included in the result of executing the job, the result being formed on the continuous paper strip, and perform control to reprint on the continuous paper strip the printed material requiring reprinting in a case where the remaining capacity of the continuous paper strip equals or exceeds the capacity of the printed material requiring reprinting.

### CROSS-REFERENCE TO RELATED APPLICATIONS

This application is based on and claims priority under 35 USC 119 from Japanese Patent Application No. 2020-155537 filed Sep. 16, 2020.

### BACKGROUND

### (i) Technical Field

The present disclosure relates to a print control apparatus and a non-transitory computer readable medium.

### (ii) Related Art

In the digital printing market, a function to verify a printing result is used to ensure the quality of printed material. A continuous-form digital printer, which prints on a continuous paper strip such as a roll of paper, records information indicating a result of inspecting each page, for example, by embedding the information in a margin of the corresponding page.

In a known method, printed material that has failed the inspection is replaced in post-processing with printed material that has been reprinted and that has passed the inspection (for example, refer to Japanese Unexamined Patent Application Publication No. 2008-87386).

### SUMMARY

One or more jobs are performed to form printed material on a continuous paper strip, and a portion of the continuous paper strip having no printed material is usually discarded as the remainder.

Aspects of non-limiting embodiments of the present disclosure relate to providing a print control apparatus that makes a discarded portion of a continuous paper strip smaller than in a case where nothing is reprinted on the continuous paper strip that has undergone one or more jobs.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a print control apparatus including a processor configured to acquire a remaining capacity of a continuous paper strip on which a result of executing a job is printed, acquire a capacity of printed material requiring reprinting, the printed material being included in the result of executing the job, the result being formed on the continuous paper strip, and perform control to reprint on the continuous paper strip the printed material requiring reprinting in a case where the remaining capacity of the continuous paper strip equals or exceeds the capacity of the printed material requiring reprinting.

### BRIEF DESCRIPTION OF THE DRAWINGS

Exemplary embodiments of the present disclosure will be described in detail based on the following figures, wherein:

FIG. 1 is a block diagram of a printing system according to a first exemplary embodiment;

FIG. 2 is a flowchart depicting a process to control job execution when a single job is executed according to the first exemplary embodiment;

FIG. 3 is a flowchart depicting another process to control job execution when a single job is executed according to a second exemplary embodiment;

FIG. 4 is a flowchart depicting a process to control job execution when a plurality of jobs are executed according to a third exemplary embodiment;

FIGS. 5A, 5B, and 5C are each a conceptual diagram depicting an order of a plurality of jobs including reprinting jobs according to the third exemplary embodiment and a fourth exemplary embodiment; and

FIG. 6 is a flowchart depicting another process to control job execution when a plurality of jobs are executed according to the fourth exemplary embodiment.

### DETAILED DESCRIPTION

Hereinafter, exemplary embodiments of the present disclosure will be described with reference to the drawings.

### First Exemplary Embodiment

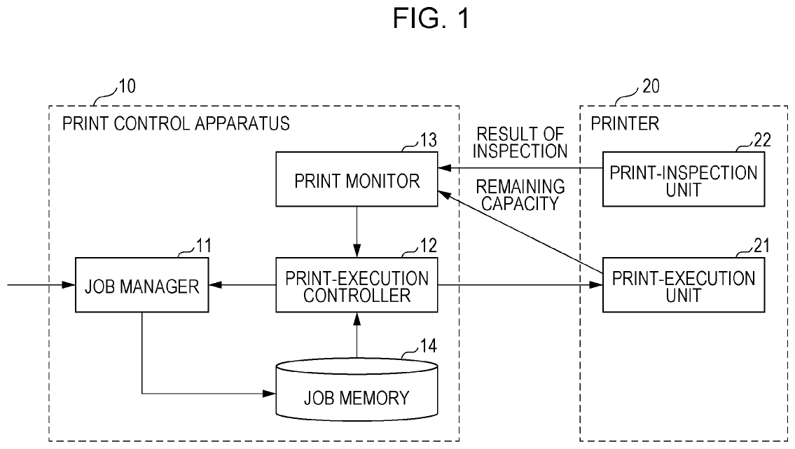

FIG. 1 is a block diagram of a printing system according to a first exemplary embodiment. FIG. 1 depicts a printer 20 that performs printing and a print control apparatus 10 that controls printing performed by the printer 20.

The printer 20 according to the present exemplary embodiment is a continuous-form digital printer, which prints on a continuous paper strip such as a roll of paper. The printer 20 includes a print-execution unit 21 that performs printing and a print-inspection unit 22 that performs inspection of printed material that is output from the print-execution unit 21.

The print-execution unit 21 follows an instruction from the print control apparatus 10 and prints on a continuous paper strip by performing one or more jobs. Since the print-execution unit 21 basically performs a job to form a plurality of pages on a continuous paper strip, a piece of printed material formed by the print-execution unit 21 corresponds to a page. The print-inspection unit 22 performs an inspection of a page at a time. The print-execution unit 21 has not only a function of detecting a capacity of a continuous paper strip placed in the printer 20 but also a function of detecting an amount of continuous paper consumed by forming printed material, in other words, a remaining capacity of a continuous paper strip.

The term “capacity” indicates an amount of space available for printing on a sheet of paper. The term “capacity of printed material” indicates an amount of space required to print the printed material on a sheet of paper. The term “remaining capacity” indicates a capacity that remains unused for printing after a printing process has been performed. If every piece of printed material created and printed on a continuous paper strip has the same size (for example, all pages have the A4 size), a capacity can be converted into and represented by such a parameter as the number of pages or the length of a roll of paper. In contrast, if pieces of printed material have different sizes, for example, if pieces of printed material having various sizes such as A4 and B5 coexist, the amount of continuous paper that is consumed varies depending on the size of a piece of printed material. Thus, a capacity is represented by an area such as cm². In the present exemplary embodiment described below, a capacity and a remaining capacity are each represented by an area.

As described above, the print control apparatus 10 according to the present exemplary embodiment controls printing performed by the printer 20. The print control apparatus 10 may be constructed by using a hardware configuration based on a general-purpose computer known in the art. Specifically, the print control apparatus 10 is constructed by connecting to an internal bus a central processing unit (CPU), a read-only memory (ROM), a random-access memory (RAM), a hard disk drive (HDD) as a storage unit, a network interface (IF) installed as a communication unit, and a user interface including an input unit and a display unit as necessary.

As depicted in FIG. 1, the print control apparatus 10 according to the present exemplary embodiment includes a job manager 11, a print-execution controller 12, a print monitor 13, and a job memory 14. In FIG. 1, units that are not used for descriptions of the present exemplary embodiment are omitted.

The job manager 11 accepts a job as a print request and registers the job in the job memory 14. The job manager 11 also performs such management as job management and schedule management. The job management includes registering and removing a job, and the schedule management includes determining an order of execution of registered jobs. The print-execution controller 12 performs control so as to execute jobs in accordance with a schedule, the jobs being registered in the job memory 14. The print monitor 13 monitors various conditions such as a printing condition and an inspection condition of the printer 20. In the present exemplary embodiment, the print monitor 13 acquires a remaining capacity of a continuous paper strip from the print-execution unit 21 and a result of inspecting each piece of printed material from the print-inspection unit 22 as depicted in FIG. 1.

The job memory 14 stores pieces of job information each including, for example, information to identify a job, such as a job identification (ID), a date and time of acceptance of a job, a job size, an amount of printed material (such as page sizes, the number of sheets of each page size, and a capacity of a continuous paper strip to be used), and information to identify a continuous paper strip on which printed material is formed. In addition, for example, an order of pieces of job information determines an order of execution of jobs, in other words, schedule information. A data structure used in the art can be set up for the job memory 14.

Each of the units numbered from 11 to 13 of the print control apparatus 10 is provided by cooperation between a computer constituting the print control apparatus 10 and programs running on the CPU installed in the computer. The job memory 14 is constructed by using the HDD installed in the print control apparatus 10. Alternatively, the RAM or a storage unit located outside may be used via a network.

The programs used in the present exemplary embodiment may be provided not only via the communication unit but also in a stored form by using a recording medium readable by a computer, such as a compact-disc ROM (CD-ROM) or a universal-serial-bus (USB) memory. The programs provided by using the communication unit or the recording medium are installed into the computer, and the CPU of the computer executes the programs consecutively to perform various processes.

The printing system executes a job and forms printed material on a continuous paper strip as a result of executing the job. Printed material is created and printed as specified by such information as attribute information but sometimes fails to achieve an expected quality, for example, because of a smear at a nozzle that ejects ink. The print-inspection unit 22 performs an inspection of the quality of each piece of created printed material and fails a piece of printed material that does not meet a predetermined criterion.

Printed material that has failed the inspection is reprinted. The term “reprint” as used in the present exemplary embodiment indicates creating a new job so as to achieve a quality that passes an inspection, executing the new job, and thereby obtaining new printed material that passes the inspection instead of the printed material that has failed the inspection. In the present exemplary embodiment, for the sake of description, it is assumed that printed material that passes an inspection is obtained by performing reprinting. If printed material obtained by performing reprinting fails the inspection, reprinting can be performed again.

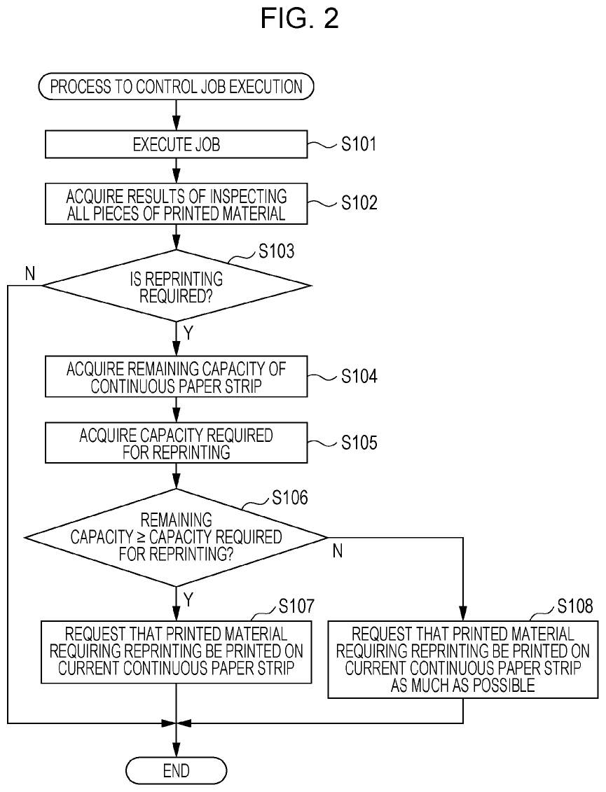

In the present exemplary embodiment, in a case where printed material that has failed an inspection is reprinted, control is performed to reprint the printed material, if possible, on the continuous paper strip on which the printed material that has failed the inspection has been formed. Basic procedures in a print control process according to the present exemplary embodiment will be described below with reference to the flowchart depicted in FIG. 2. FIG. 2 depicts a process to form printed material on a continuous paper strip by performing a single job.

The print-execution controller 12 retrieves a job from the job memory 14 and sends the job to the printer 20, causing the printer 20 to execute the job (step S101).

The print-execution unit 21 of the printer 20 starts to execute the received job and registers the remaining capacity of the continuous paper strip at the starting time. The remaining capacity of the continuous paper strip at the starting time equals the remaining capacity of the continuous paper strip at the ending time of the job immediately preceding the current job. Then, the print-execution unit 21 completes the current job after forming a plurality of pieces of printed material on the continuous paper strip and registers the remaining capacity of the continuous paper strip at the ending time.

In response to the creation of every piece of printed material by the print-execution unit 21, the print-inspection unit 22 performs an inspection of the piece of printed material. In response to the completion of execution of the current job, the print monitor 13 acquires results of inspecting all the pieces of printed material from the print-inspection unit 22 (step S102). In a case where all the pieces of printed material have passed the inspection and there is no piece of printed material that requires reprinting because of failure to pass the inspection (N in step S103), the process related to the current job ends.

In contrast, in a case where there is at least one piece of printed material that requires reprinting because of failure to pass the inspection (Y in step S103), the print monitor 13 acquires the remaining capacity of the continuous paper strip from the print-execution unit 21 (step S104).

Subsequently, the print-execution controller 12 acquires the total capacity of the printed material requiring reprinting (step S105). Since each piece of printed material requiring reprinting can be specified, the print-execution controller 12 refers to the job memory 14 and obtains information from the printer 20 to acquire the capacity of each piece of printed material requiring reprinting. Then, the print-execution controller 12 totals the capacities and acquires the total capacity.

Subsequently, the print-execution controller 12 acquires the remaining capacity of the continuous paper strip from the print monitor 13 and compares the remaining capacity with the total capacity of the printed material requiring reprinting. In a case where the remaining capacity of the continuous paper strip equals or exceeds the total capacity of the printed material requiring reprinting (Y in step S106), the print-execution controller 12 requests the job manager 11 to reprint on the continuous paper strip (referred to as the “current continuous paper strip” below) the printed material requiring reprinting (step S107). The current continuous paper strip is where the printed material obtained as a result of executing the current job, namely, a mixture of printed material that has passed the inspection and printed material that has failed the inspection has been formed. Since the current continuous paper strip has the remaining capacity that suffices for reprinting the printed material that has failed the inspection, reprinting is controlled so as to be performed on the current continuous paper strip in this case according to the present exemplary embodiment.

At the request of the print-execution controller 12, the job manager 11 newly creates a job to print the printed material requiring reprinting and registers the job so as to print on the current continuous paper strip the printed material requiring reprinting. The request of the print-execution controller 12 includes information (for example, a job ID and a page number) to specify each piece of printed material requiring reprinting.

In contrast, in a case where the remaining capacity of the continuous paper strip is less than the total capacity of the printed material requiring reprinting (N in step S106), the remaining capacity of the current continuous paper strip is insufficient for reprinting of all the printed material requiring reprinting. In this case, control may be performed so that all the printed material requiring reprinting are collectively formed on a continuous paper strip that differs from the current continuous paper strip. However, the print-execution controller 12 according to the present exemplary embodiment requests the job manager 11 to extract from the printed material requiring reprinting a portion of the printed material that can be accommodated within the remaining capacity of the current continuous paper strip, thereby utilizing the remainder of the current continuous paper strip as efficiently as possible (step S108).

To print the printed material requiring reprinting at the request of the print-execution controller 12, the job manager 11 newly creates both a job to print on the current continuous paper strip and a job to print on a continuous paper strip that differs from the current continuous paper strip and registers these jobs in the job memory 14. Each piece of printed material to be reprinted on the current continuous paper strip may be specified by the print-execution controller 12. Alternatively, the job manager 11 may refer to the job information registered in the job memory 14 and specify each piece of printed material to be reprinted on the current continuous paper strip.

As described above, in the present exemplary embodiment, in a case where printed material obtained as a result of executing a single job includes printed material that has failed an inspection and that requires reprinting, the printed material that requires reprinting can be formed on the current continuous paper strip to the extent possible.

### Second Exemplary Embodiment

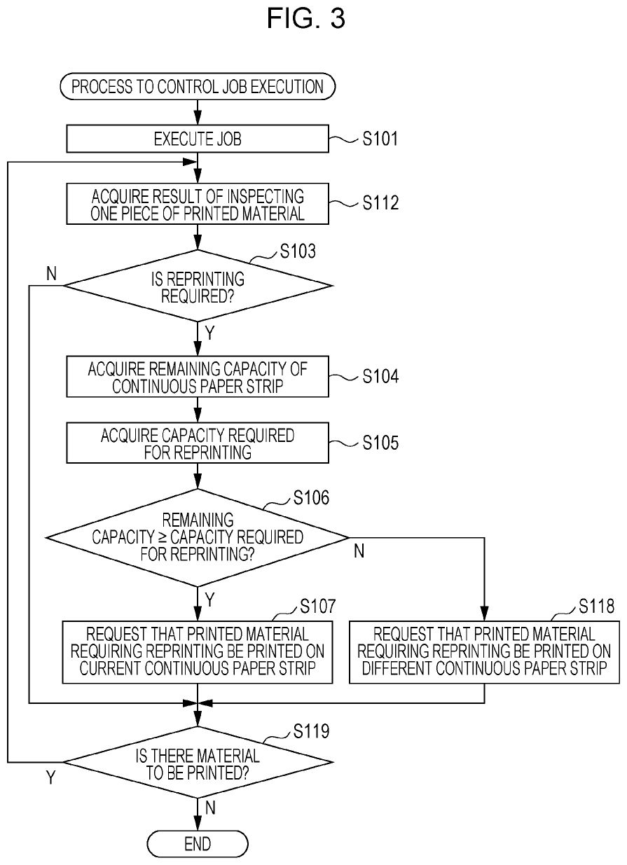

In the first exemplary embodiment described above, a description has been given of a case where a single job is executed and the print control is performed after the execution of the single job is completed and all the printed material has been created. In the present exemplary embodiment, with reference to the flowchart depicted in FIG. 3, a description will be given of a process to control job execution in a case where, while a single job is executed as in the above description, print control of printed material requiring reprinting is performed in response to the creation of every piece of printed material. The same step numbers are assigned to processes that are the same as the processes depicted in FIG. 2, and descriptions of such processes will be omitted as appropriate. The printing system may be constructed as in the first exemplary embodiment.

The print-execution controller 12 retrieves a job from the job memory 14 and sends the job to the printer 20, causing the printer 20 to execute the job (step S101). Although reprinting is performed after all the printed material is formed in the case described based on FIG. 2, reprinting is controlled as necessary in response to the creation of every piece of printed material (for example, every page) in the present exemplary embodiment.

Specifically, in response to the formation of every piece of printed material by the print-execution unit 21, the print-inspection unit 22 performs an inspection of the piece of printed material. In response to the completion of inspection of every piece of printed material, the print monitor 13 acquires the result of the inspection of the piece of printed material from the print-inspection unit 22 (step S112).

In a case where the acquired result of the inspection indicates that the piece of printed material has passed the inspection and there is no need for reprinting (N in step S103), the process proceeds to a piece of material to be printed next (Y in step S119 followed by step S112). If there is no piece of material to be printed next (N in step S119), the process related to the current job ends.

In contrast, in a case where reprinting is required because the acquired result of the inspection indicates that the piece of printed material has failed the inspection (Y in step S103), the print monitor 13 acquires the remaining capacity of the continuous paper strip from the print-execution unit 21 (step S104).

Subsequently, the print-execution controller 12 acquires the capacity of printed material requiring reprinting (step S105). In response to every detection of printed material requiring reprinting, the print-execution controller 12 acquires the capacity of the printed material requiring reprinting in this way, and the capacity of a piece of printed material (for example, a page) is acquired in this situation. Subsequently, the print-execution controller 12 compares the remaining capacity of the continuous paper strip with the capacity of the piece of printed material requiring reprinting, the remaining capacity being acquired from the print monitor 13. In a case where the remaining capacity of the continuous paper strip equals or exceeds the capacity of the piece of printed material requiring reprinting (Y in step S106), the print-execution controller 12 requests the job manager 11 to reprint on the current continuous paper strip the piece of printed material requiring reprinting (step S107).

In contrast, in a case where the remaining capacity of the continuous paper strip is less than the capacity of the piece of printed material requiring reprinting (N in step S106), no further printed material requiring reprinting can be reprinted on the current continuous paper strip. Thus, the print-execution controller 12 requests the job manager 11 to form the piece of printed material requiring reprinting on a continuous paper strip that differs from the current continuous paper strip (step S118).

A process performed by the job manager 11, which is requested by the print-execution controller 12 can be the same as above, and the description will not be repeated.

### Third Exemplary Embodiment

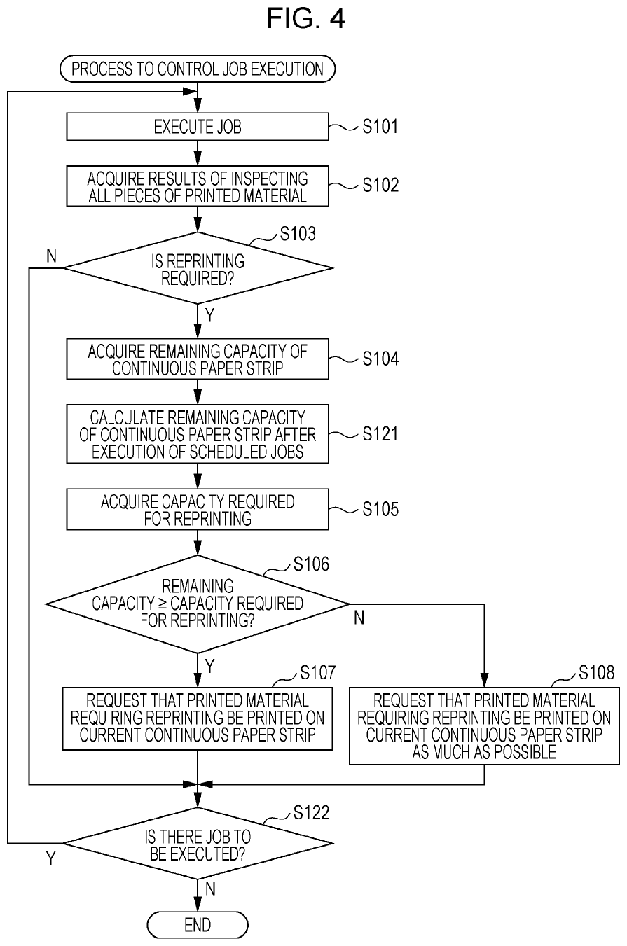

While the execution of a single job has been described in the first and second exemplary embodiments described above, execution of a plurality of jobs will be described in the present exemplary embodiment. A process to control job execution according to the present exemplary embodiment will be described below with reference to the flowchart depicted in FIG. 4. The same step numbers are assigned to processes that are the same as the processes depicted in FIG. 2, and descriptions of such processes will be omitted as appropriate. The printing system may be constructed as in the first exemplary embodiment.

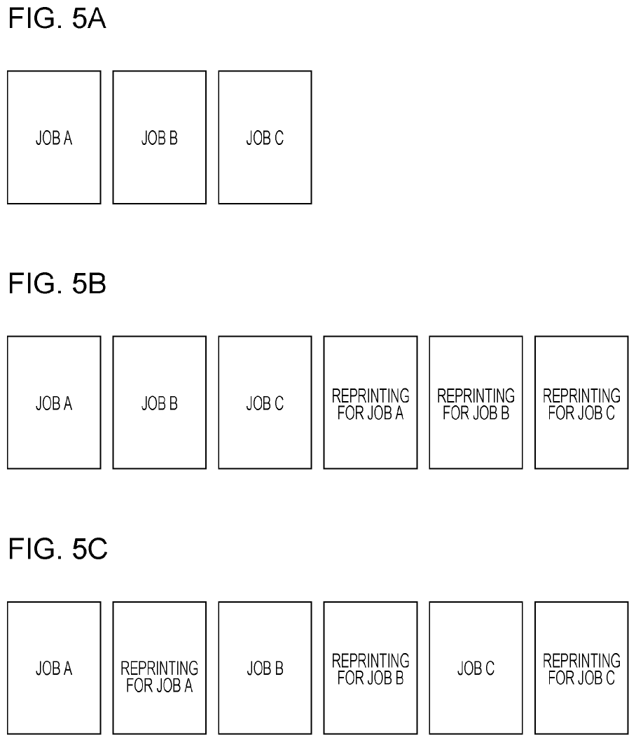

In the present exemplary embodiment, it is assumed that a schedule is arranged so that a plurality of jobs are consecutively executed and that the order of the plurality of jobs in the schedule is fixed. For example, as depicted in FIG. 5A, the jobs A, B, and C are executed in this order.

First, the print-execution controller 12 causes the print-execution unit 21 to execute a job in the schedule (step S101), and then the print-inspection unit 22 performs inspections of pieces of printed material formed on a continuous paper strip by the print-execution unit 21. In response to the completion of execution of the job, the print monitor 13 acquires results of inspecting all the pieces of printed material from the print-inspection unit 22 (step S102). In a case where all the pieces of printed material have passed the inspection and there is no piece of printed material that requires reprinting because of failure to pass the inspection (N in step S103), if there is a job to be executed next in the schedule (Y in step S122), the print-execution controller 12 causes the print-execution unit 21 to execute the job to be executed next (step S101). If there is no job to be executed next in the schedule (N in step S122), the present process ends.

In contrast, in a case where there is at least one piece of printed material that requires reprinting because of failure to pass the inspection (Y in step S103), the print-execution controller 12 acquires the remaining capacity of the continuous paper strip, the remaining capacity having been acquired by the print monitor 13 (step S104).

In the present exemplary embodiment, since the order of the jobs (in the example depicted in FIG. 5A, the jobs A, B, and C) is fixed according to the schedule, the job being currently processed (for example, the job A) is followed by jobs that are not executed yet (for example, the jobs B and C), and printed material created by the jobs that follow the current job is hereafter formed on the current continuous paper strip. Thus, the print-execution controller 12 subtracts from the acquired remaining capacity of the continuous paper strip a capacity to be used by the printed material that is formed on the current continuous paper strip by all the jobs that follow the current job. In this way, the print-execution controller 12 calculates an estimated remaining capacity of the continuous paper strip expected at the time of reprinting of printed material requiring reprinting (step S121).

Then, the print-execution controller 12 acquires the total capacity of the printed material requiring reprinting (step S105) and compares the calculated remaining capacity of the continuous paper strip with the total capacity of the printed material requiring reprinting. In a case where the remaining capacity of the continuous paper strip equals or exceeds the total capacity of the printed material requiring reprinting (Y in step S106), the printed material requiring reprinting is reprinted on the current continuous paper strip (step S107).

In contrast, in a case where the remaining capacity of the continuous paper strip is less than the total capacity of the printed material requiring reprinting (N in step S106), the remaining capacity of the current continuous paper strip is insufficient for reprinting of all the printed material requiring reprinting. Thus, the print-execution controller 12 requests the job manager 11 to extract from the printed material requiring reprinting a portion of the printed material that can be accommodated within the remaining capacity of the current continuous paper strip, thereby utilizing the remainder of the current continuous paper strip as efficiently as possible (step S108).

In the process according to the present exemplary embodiment, the printed material that is created by the jobs and that requires reprinting is scheduled to be printed after the execution of the jobs in the fixed order, namely the jobs A, B, and C in a case where the printed material requiring reprinting can be formed on the current continuous paper strip, as depicted in FIG. 5B. FIG. 5B depicts a situation in which jobs for reprinting are created also for the jobs B and C.

### Fourth Exemplary Embodiment

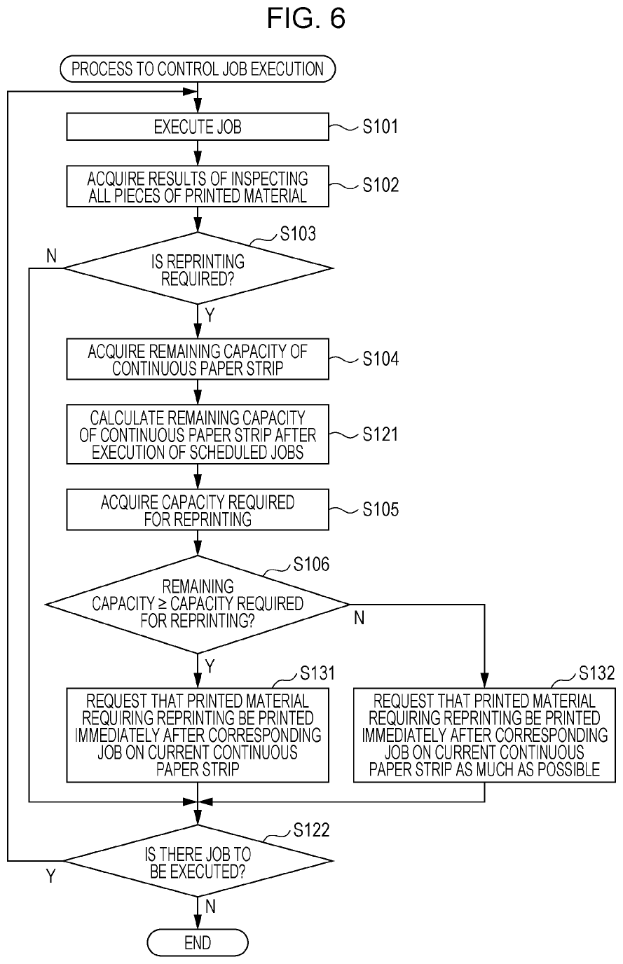

In the third exemplary embodiment described above, a plurality of jobs are executed, and the order of execution of the scheduled jobs is fixed. In the present exemplary embodiment, the order of execution of the scheduled jobs can be changed. For example, in response to the completion of execution of every job, the print-execution controller 12 instructs the print-execution unit 21 to execute a job to be executed next. A process to control job execution according to the present exemplary embodiment will be described with reference to the flowchart depicted in FIG. 6. The same step numbers are assigned to processes that are the same as the processes depicted in FIG. 4, and descriptions of such processes will be omitted as appropriate. The printing system may be constructed as in the first exemplary embodiment.

Processes according to the present exemplary embodiment are the same as the processes in steps S101 to S106 according to the third exemplary embodiment, and descriptions of such processes will be omitted. In a case where the remaining capacity of the continuous paper strip equals or exceeds the total capacity of the printed material requiring reprinting (Y in step S106), the print-execution controller 12 requests the job manager 11 to reprint the printed material requiring reprinting on the current continuous paper strip immediately after the printed material created by the execution of the job that has created the printed material requiring reprinting (step S131).

Although the jobs A, B, and C are scheduled to be executed consecutively as depicted in FIG. 5A, control is performed according to the present exemplary embodiment so that a job for reprinting is executed immediately after the job that has created printed material requiring reprinting as depicted in FIG. 5C. Specifically, in the example depicted in FIG. 5A, of the plurality of jobs A, B, and C, the execution of the job B has been scheduled to follow the execution of the job A, which is the first job, but the job to perform reprinting for the job A is scheduled to intervene immediately after the job A and immediately before the job B as depicted in FIG. 5C.

In contrast, in a case where the remaining capacity of the continuous paper strip is less than the total capacity of the printed material requiring reprinting (N in step S106), the remaining capacity of the current continuous paper strip is insufficient for reprinting of all the printed material requiring reprinting. Thus, the print-execution controller 12 requests the job manager 11 to extract from the printed material requiring reprinting a portion of the printed material that can be accommodated within the remaining capacity of the current continuous paper strip, thereby utilizing the remainder of the current continuous paper strip as efficiently as possible (step S132).

If print control is performed for reprinting as described above, the completion of the first job (for example, the job A) can be immediately followed by the execution of the job to reprint printed material that has failed the inspection accompanying the execution of the job A (“reprinting for job A” in FIG. 5C), and thus the printed material can efficiently be replaced.

Although printing the jobs A, B, and C on the same continuous paper strip is prioritized in the above example, executing the “reprinting for job A” for reprinting immediately after the completion of the “job A” may be prioritized. For example, in a case where the remaining capacity of the continuous paper strip is less than the total capacity of the printed material requiring reprinting (N in step S106), the jobs are rescheduled so that the “reprinting for job A” for reprinting is executed immediately after the completion of the “job A”, which is executed as the first job. Consequently, of the plurality of jobs A, B, and C, either the job C or the jobs B and C, which have not been executed yet, may be unable to form printed material on the same continuous paper strip as the job A. Thus, at the request of the print-execution controller 12, the job manager 11 rearranges the schedule so that printed material obtained as a result of executing either the job C or the jobs B and C is printed on another continuous paper strip.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A print control apparatus comprising:
a processor configured to
acquire a remaining capacity of a continuous paper strip on which a result of executing a job is printed,
acquire a capacity of printed material requiring reprinting, the printed material being included in the result of executing the job, the result being formed on the continuous paper strip, and
perform control to reprint on the continuous paper strip the printed material requiring reprinting in a case where the remaining capacity of the continuous paper strip equals or exceeds the capacity of the printed material requiring reprinting.

2. The print control apparatus according to claim 1,
wherein the processor is configured to
acquire a total capacity of all printed material requiring reprinting in response to completion of execution of the job, and
perform control to reprint on the continuous paper strip all the printed material requiring reprinting in a case where the remaining capacity of the continuous paper strip at the completion of execution of the job equals or exceeds the total capacity of all the printed material requiring reprinting.

3. The print control apparatus according to claim 2,
wherein the processor is configured to
perform control to reprint on the continuous paper strip a portion of all the printed material requiring reprinting in a case where the remaining capacity of the continuous paper strip at the completion of execution of the job is less than the total capacity of all the printed material requiring reprinting, and
wherein a size of the portion is within the remaining capacity of the continuous paper strip.

4. The print control apparatus according to claim 1,
wherein the processor is configured to acquire the capacity of the printed material requiring reprinting in response to every detection of the printed material requiring reprinting.

5. The print control apparatus according to claim 1,
wherein, in a case where a result of executing a plurality of jobs is scheduled to be printed on the continuous paper strip,
the processor is configured to
acquire an estimated remaining capacity of the continuous paper strip after the result of executing the plurality of jobs is printed,
acquire a capacity of printed material requiring reprinting, the printed material being included in the result of executing a first job included in the plurality of jobs, the result being formed on the continuous paper strip and
perform control to reprint on the continuous paper strip the printed material requiring reprinting in a case where the estimated remaining capacity of the continuous paper strip equals or exceeds the capacity of the printed material requiring reprinting, and
wherein the printed material requiring reprinting is included in the result of executing the first job.

6. The print control apparatus according to claim 5,
wherein the processor is configured to
perform control to reprint the printed material requiring reprinting immediately after completion of a job currently performing printing, and
wherein the printed material requiring reprinting is included in the result of executing the first job.

7. The print control apparatus according to claim 5,
wherein, in a case where the estimated remaining capacity of the continuous paper strip is less than the capacity of the printed material requiring reprinting,
the processor is configured to
perform control to reprint on the continuous paper strip the printed material requiring reprinting, and
rearrange a schedule so that a result of executing one or more jobs that have not been executed is printed on another continuous paper strip,
wherein the printed material requiring reprinting is included in the result of executing the first job, and
wherein the one or more jobs are included in the plurality of jobs and differ from the first job.

8. A non-transitory computer readable medium storing a program causing a computer to execute a process for print control, the process comprising:
acquiring a remaining capacity of a continuous paper strip on which a result of executing a job is printed;
acquiring a capacity of printed material requiring reprinting, the printed material being included in the result of executing the job, the result being formed on the continuous paper strip; and
performing control to reprint on the continuous paper strip the printed material requiring reprinting in a case where the remaining capacity of the continuous paper strip equals or exceeds the capacity of the printed material requiring reprinting.

9. A print control apparatus comprising:
means for acquiring a remaining capacity of a continuous paper strip on which a result of executing a job is printed;
means for acquiring a capacity of printed material requiring reprinting, the printed material being included in the result of executing the job, the result being formed on the continuous paper strip; and
means for performing control to reprint on the continuous paper strip the printed material requiring reprinting in a case where the remaining capacity of the continuous paper strip equals or exceeds the capacity of the printed material requiring reprinting.
